(19) United States
(12) Patent Application Publication
(10) Pub. No.: US 2011/0126782 A1
(43) Pub. Date: Jun. 2, 2011

(54) THERMOSTATIC CONTROL OF VEHICLE HEATER COOLANT CIRCUIT TO MAXIMIZE CABIN HEATER PERFORMANCE

(75) Inventor: Gregory Saele, Itasca, IL (US)

(73) Assignee: International Truck Intellectual Property Company,, Warrenville, IL (US)

(21) Appl. No.: 12/628,436

(22) Filed: Dec. 1, 2009

(51) Int. Cl. F01P 7/14; F02M 25/07

(52) U.S. Cl. 123/41.1; 123/568.12

(57) ABSTRACT

A coolant circulation system for an internal combustion engine includes an exhaust gas recirculation system coolant circuit and a cabin heating circuit. The exhaust gas recirculation system coolant circuit includes a heat exchanger to extract heat from exhaust gases into the engine coolant. The cabin heating circuit includes a heat exchanger for sinking heat into a vehicle cabin. An exhaust gas recirculation flow control valve controls the flow of exhaust gas flowing through the exhaust gas recirculation line and through the line heat exchanger. The exhaust gas recirculation flow control valve is closed when the engine is not warm enough. A heater control valve controls the flow of coolant through the cabin heating circuit. Opening and closing of the heater control valve is made responsive to direct or indirect indication of engine temperature in order to maintain engine temperature by restricting flow to the cabin heating circuit. This keeps the exhaust gas recirculation valve open which maximizes heat input to the coolant, which in turn maximizes heat available to warm a vehicle cabin.

### BACKGROUND

1. Technical Field

The technical field relates to management of engine cooling systems on motor vehicles and more particularly to the interaction of vehicle passenger cabin heating with engine heat management.

2. Background Description

Vehicles powered by liquid-cooled combustion engines frequently rely on using engine coolant for heating the vehicle passenger cabin. For vehicles with relatively large passenger cabins, such as trucks and buses, coolant may be circulated through an extended heating circuit to provide heat through much of the extent of the cabin. A valve modulates coolant flow in the heating circuit in response to requests for heat in the cabin.

School buses are subject to frequent stops during which a passenger door is opened to allow children to board or disembark. During such periods the vehicle engine is usually allowed to idle. During cold weather warm air can be lost from the bus passenger compartment to the environment through an open door. At such times more heat can be lost from the passenger compartment heating circuit than the engine generates, resulting in a progressively declining coolant temperature and overcooling of the engine.

School buses and trucks are often equipped with diesel engines and some of these provide for exhaust gas recirculation (EGR) for pollution control. EGR systems provide a valve for diverting a controlled amount of exhaust gas to the engine's intake manifold. In order to prevent the recirculated exhaust gas from returning excessively hot exhaust gas to the engine's intake system a heat exchanger (cooler) is built into the exhaust gas recirculation system to sink heat from the recirculated gas to the engine coolant. On some vehicles the exhaust gas recirculation (EGR) control valve is closed when the engine is cold to prevent fouling of the EGR cooler/heat exchanger and the EGR valve. Exhaust gas contains inert elements such as molecular nitrogen, water and carbon dioxide which because of their molar specific heats carry substantial thermal energy. Thus placing a heat exchanger in an EGR system can capture a substantial amount of the heat. In normal operation of an engine with an EGR system, a significant portion of the heat available for passenger cabin heating can be recovered from the EGR system.

In some instances, the amount of heat delivered to the cabin can result in the engine being cooled to the point that the EGR valve controlling diversion of exhaust gas closes cutting off exhaust gas recirculation. In this case, exhaust heat which would have been captured by the engine cooling system via the EGR cooler/heat exchanger is instead discharged directly to the environment as hot exhaust. With no heat being absorbed by the EGR cooler/heat exchanger, less heat is available for heating the bus passenger cabin. Under these conditions it is possible that the engine cooling system may not extract enough heat from the engine to regain the desired temperature in the passenger cabin, resulting in the heater circuit valve remaining open. With heat being discharged continuously into the passenger cabin the engine may not build up enough heat to reopen the EGR valve, affecting engine performance, emissions of exhaust pollutants, and heat available for the cabin.

### SUMMARY

A coolant circulation system for an internal combustion engine includes an exhaust gas recirculation system coolant circuit and a cabin heating circuit. The exhaust gas recirculation system coolant circuit includes a heat exchanger for extracting heat from an exhaust gas recirculation line. The cabin heating circuit includes a heat exchanger for sinking/radiating heat into a vehicle cabin. An exhaust gas recirculation flow control valve provides for control over the quantity of exhaust gas flowing through the exhaust gas recirculation line and through the line heat exchanger. A heater control valve in the cabin heating circuit is positionable to control the flow of coolant through the cabin heating circuit. The coolant circulation system may further include radiator circuit for sinking heat and radiator flow control valve (thermostat) for controlling flow in the radiator circuit. Coolant flow is modulated by the thermostat to promote retention of heat in the cooling system in order to keep the engine within normal operating parameters, including EGR valve open. Coolant flow to the cabin heater circuit is likewise controlled in order to promote retention of heat in the cooling system, specifically to keep the EGR valve open in order to maximize heat input into the coolant, thus maximizing overall vehicle heater performance.

### BRIEF DESCRIPTION OF THE DRAWINGS

FIG. 1 is a perspective view of a school bus which provides an operating application for the present heat management system.

FIG. 2 is a schematic of a vehicle coolant circulation system.

FIG. 3 is a schematic illustrating an alternative embodiment of the vehicle coolant circulation system.

FIG. 4 is a schematic illustrating yet another alternative embodiment of the vehicle coolant circulation system

### DETAILED DESCRIPTION

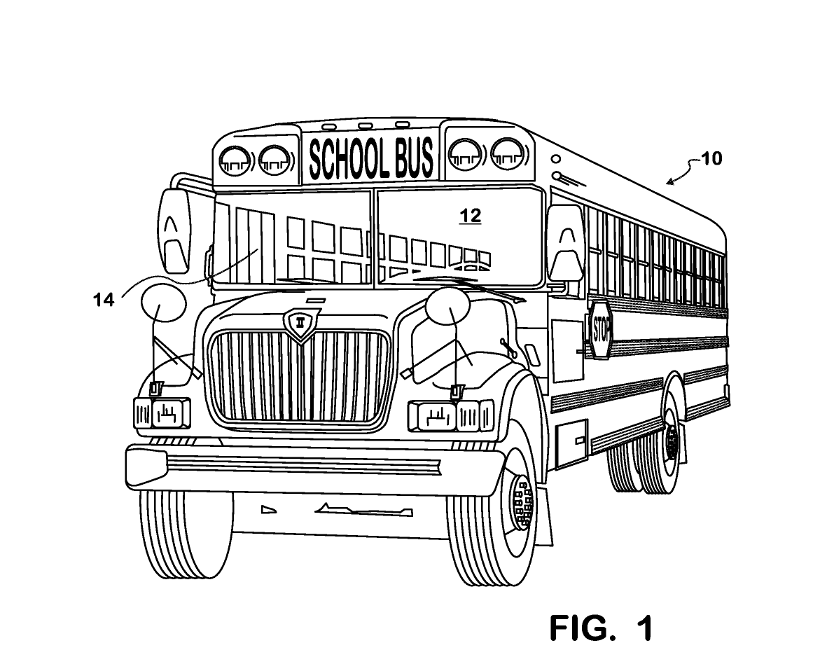

FIG. 1 shows a motor vehicle 10, such as a school bus, which uses engine coolant for heating a cabin 12. The cabin 12 may be periodically opened to the environment through opening of passenger door 14. During cold weather opening passenger door 14 entails of a loss of warmed air to the outside.

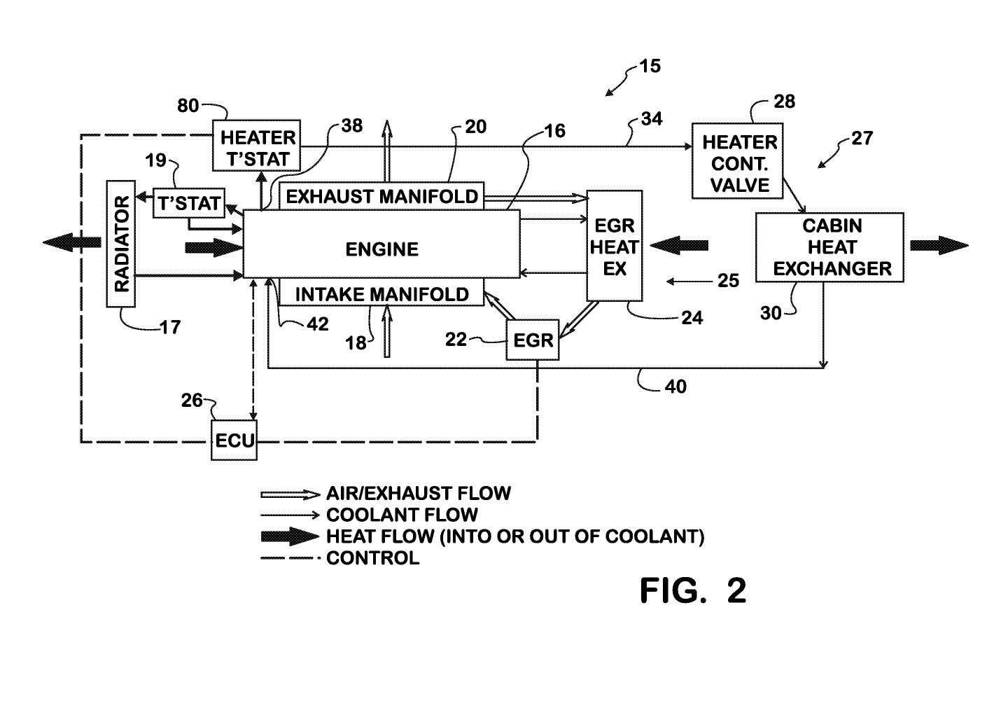

FIG. 2 is a schematic illustration of a motor vehicle 10 liquid coolant circulation system 15 installed on motor vehicle 10 to extract heat from an internal combustion engine 16 and from an exhaust gas recirculation (EGR) heat exchanger 24 in an exhaust gas recirculation (EGR) line 36. While internal combustion engines with circulating coolant systems conventionally use a liquid coolant, and the present embodiments are described with reference to a liquid coolant, a contained circulating coolant system using a gas coolant or a coolant that undergoes phase changes is possible. The liquid coolant circulation system 15 provides one mechanism of internal combustion engine 16 heat management.

Heat is generated by internal combustion engine 16 during the combustion process. Internal combustion engine 16 draws air from the environment via an intake manifold 18, combusts fuel with oxidizer from the air and discharges the byproduct (exhaust gas) of the combustion process into an exhaust manifold 20. Conventionally exhaust gas is discharged from the exhaust manifold 20 to the environment, but depending upon engine operating conditions, a portion of the exhaust gas may be diverted for recirculation from the exhaust manifold to the intake manifold 18. An exhaust gas recirculation control valve 22 under the control of an engine control unit (ECU) 26 may be used to divert a controlled amount of exhaust gas through an exhaust gas recirculation (EGR) circuit 25 from the exhaust manifold 20 to the intake manifold 18. The diverted exhaust gas is cooled before introduction to the intake manifold 18 by inclusion of an EGR heat exchanger 24 in the EGR circuit 25. The EGR heat exchanger 24 is part of the engine cooling system and is in communication with the liquid coolant circulation system to circulate coolant from internal combustion engine 16 through EGR heat exchanger 24 to draw heat from the diverted exhaust gas. This heat can be sunk to the radiator 17 in a radiator circuit or a cabin heat exchanger 30.

An engine control unit (ECU) 26 may modulate the position of exhaust gas recirculation (EGR) control valve 22 based on engine temperature, indicated directly from the temperature of the coolant, or based on other engine operating variables. EGR control valve 22 may be closed to restrict or prevent the recirculation of exhaust gas to the intake manifold when the engine temperature is below a predetermined minimum. At such times the amount of heat extracted by the liquid coolant circulation system 15 is reduced because the heat carried by the exhaust gas is directly discharged to the environment with the exhaust gas. In addition, a thermostat 19 may be provided to control coolant flow from internal combustion engine 16 to the radiator 17 to maintain the coolant in the desired temperature range for engine 16.

The liquid coolant circulation system 15 includes a heating circuit 27 which sinks heat into the cabin 12 of the vehicle 10. Heated coolant is circulated through the cabin 12 in the heating circuit, and particularly through a cabin heat exchanger 30, to supply heat to the cabin 12. Cabin heat exchanger 30 is part of the heating circuit 27. Heating circuit 27 runs from an engine coolant outlet 38 along a heating system feed line 34 to a cabin heat control valve 28, from the cabin heat control valve 28 through the cabin heat exchanger 30 and back via a heating system return line 40 to an inlet 42 to the internal combustion engine 16. The cabin heat exchanger 30 extracts heat from the engine coolant for the purpose of warming the cabin 12.

Cabin 12 heating is controlled by operator adjustment of the cabin heat control valve 28 to modulate coolant flow from the engine through the heating circuit 27. Independent of cabin heat control valve 28, a cabin heating circuit thermostat 80 prevents coolant flow through the heating circuit 27 when the engine is not warm enough for the EGR valve 22 to be opened. The cabin heating circuit thermostat 80 modulates coolant flow to the heating circuit 27 to maintain sufficient heat in the engine coolant directed to keeping the EGR valve 22 open. Cabin heating circuit thermostat 80 may be a simple mechanical device such as a wax element style thermostat which opens in proportion to coolant temperature, or may be electronically controlled based on coolant temperature or other engine operating variables.

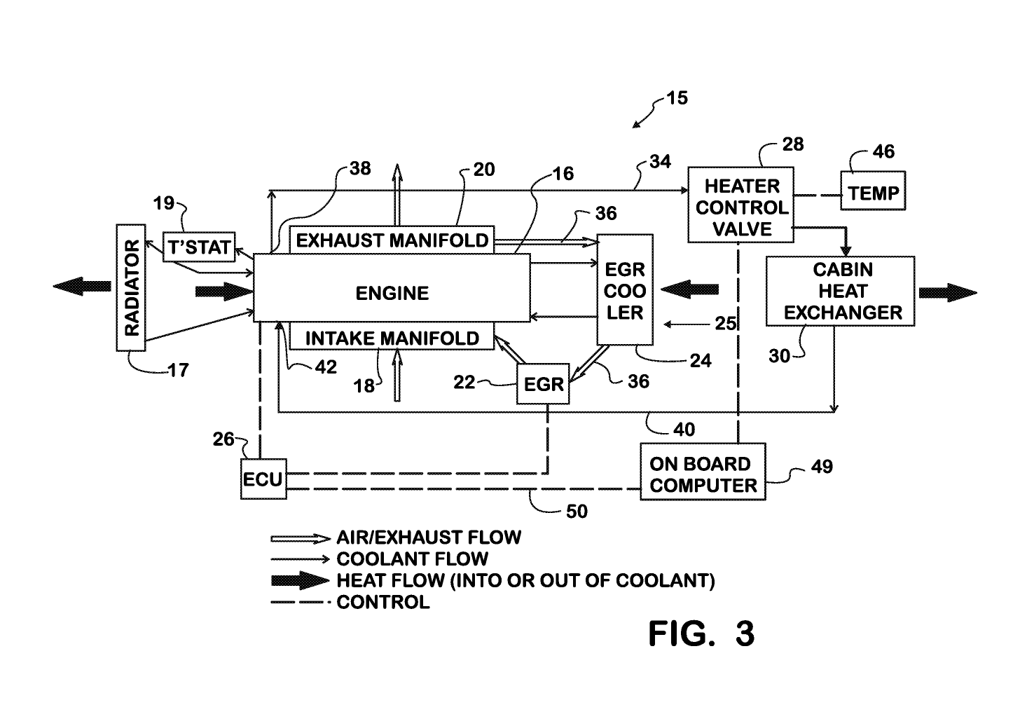

Referring to FIG. 3, cabin 12 heating may alternatively be controlled by having a cabin heat control module 32 adjust the position of the cabin heat control valve 28 between open and closed to modulate coolant flow in response to an operator input or climate control system request. Temperature readings from a cabin temperature sensor 46 may be used if an automated climate control system with cabin temperature sensor is present. Onboard computer (OC) 49 may also be the mechanism which mediates operator inputs or selection of a target temperature for the cabin 12 in an automated system. Signals may be passed between the engine control unit (ECU) 26 and the cabin heat control module 32 by the onboard computer 49 and an associated network 50, usually a controller area network (CAN). Onboard computer 49 is aware of values for engine operating variables such as coolant temperature received from ECU 26 over network 50. Control logic in the onboard computer 49, ECU 26, or cabin heat control module 32 can use engine coolant temperature or another engine operating variable to determine whether coolant flow to the heating circuit 27 needs to be restricted in order to keep the exhaust gas recirculation valve 22 open, and instructs the cabin heat control valve 28 to open or close accordingly, overriding operator or climate control system requests that otherwise would result in the cabin heat control valve 28 being more fully open.

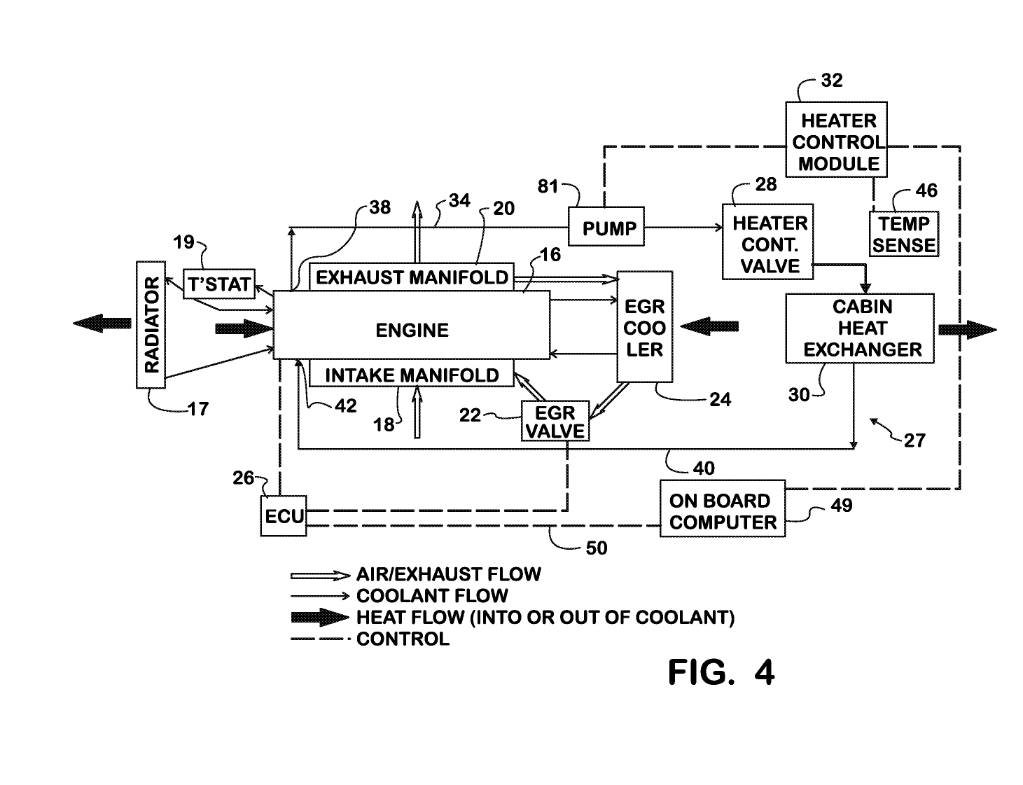

Referring to FIG. 4, a cabin 12 heating circuit 27 has a pump 44 to boost coolant flow through the cabin heat exchanger 30. Engagement or disengagement of pump 44, and potentially pump 44 operating speed, can be made responsive to coolant temperature or other engine operating variables in order to keep the EGR valve 22 open by utilizing logic in the onboard computer 49, ECU 26, or cabin heat control module 32. Trigger engine temperature levels for restricting flow through the heating circuit 27 by closing the cabin heat control valve 28 or disengaging the pump 44 are preferably set at a temperature sufficiently higher than the temperature at which the EGR valve would be closed in order to prevent the EGR system from cycling between valve open and valve closed. This allows operational adjustments for taking into account heater performance, engine exhaust emissions, and EGR system durability. The control logic can be modified include built in hysteresis in support of the same performance criteria.

What is claimed is:

1. A heat management system for a vehicle engine, the heat management system comprising:
an exhaust gas recirculation system coupled between an exhaust manifold from the vehicle engine to an intake manifold for the vehicle engine;
a coolant circulation system for the vehicle engine including a radiator circuit, an exhaust gas recirculation coolant circuit and a cabin heating circuit;
means responsive to coolant or vehicle engine temperature for controlling diversion of exhaust gas through the exhaust gas recirculation system;
an exhaust gas recirculation heat exchanger coupled with the exhaust gas recirculation coolant circuit and thermally coupled with the exhaust gas recirculation system for absorbing heat from exhaust gas diverted through the exhaust gas recirculation system and sinking the heat to the exhaust gas recirculation coolant circuit;
the cabin heating circuit comprising a heat exchanger;
means for modulating coolant flow through the cabin heating circuit; and
the means for modulating being responsive to thermal input into the coolant circulation system from the vehicle engine and exhaust gas recirculation heat exchanger being insufficient to meet heat demand from the cabin heating circuit.

2. A heat management system as set forth in claim 1, further comprising:
the means for modulating being responsive to one of a plurality of engine operating variables including coolant temperature; and
the means for modulating being operative to keep the engine above a minimum operating temperature relating to keeping the exhaust gas recirculation valve open.

3. A vehicle comprising:
an internal combustion engine having an intake manifold and an exhaust manifold;
an exhaust gas recirculation system connecting the exhaust manifold and the intake manifold;
an exhaust gas recirculation control valve in the exhaust gas recirculation line;
a heat exchanger thermally coupled to the exhaust gas recirculation line;
an engine cooling system including a liquid coolant circulation system, the liquid coolant circulation system including a circuit for drawing heat from the exhaust gas recirculation line connected to the heat exchanger;
a passenger cabin;
the liquid coolant circulation subcircuit at least partially located in the passenger cabin;
a flow control valve in the heater circuit; and
a controller for the flow control valve in the heater subcircuit responsive to an engine operating variable controlling positioning of the exhaust gas recirculation control valve for opening and closing the flow control valve.

4. A vehicle as set forth in claim 3, further comprising:
the flow control valve in the heater circuit opening when engine temperature exceeds a minimum temperature at which exhaust gas is diverted through the exhaust gas recirculation system.

5. An engine cooling system comprising:
an exhaust gas cooling circuit through which coolant circulates;
a vehicle cabin heating circuit through which coolant circulates;
means for controlling coolant flow through the vehicle cabin heating circuit;
means responsive to an operator or climate control system request for allowing coolant flow through the vehicle cabin heating circuit; and
means responsive to an engine operating variable relating to engine temperature falling below an operating minimum for modulating coolant flow through the vehicle cabin heating circuit notwithstanding an active operator or climate control system request.
